(19) United States
(12) Patent Application Publication
(10) Pub. No.: US 2016/0329146 A1
(43) Pub. Date: Nov. 10, 2016

(54) POWER INDUCTOR AND METHOD OF MANUFACTURING THE SAME

(71) Applicant: SAMSUNG ELECTRO-MECHANICS CO., LTD., Suwon (KR)

(72) Inventors: Hwan-Soo LEE, Suwon (KR); Kang Heon HUR, Suwon (KR); Jung Min PARK, Suwon (KR); Hye Yeon CHA, Suwon (KR)

(21) Appl. No.: 15/215,247

(22) Filed: Jul. 20, 2016

Related U.S. Application Data
(62) Division of application No. 13/729,735, filed on Dec. 28, 2012.

(30) Foreign Application Priority Data
Dec. 29, 2011 (KR) 10-2011-0145750

(51) Int. Cl. H01F 27/28; H01F 27/245; H01F 27/255; H01F 27/29

(52) U.S. Cl. CPC H01F 27/2804; H01F 27/292; H01F 27/245; H01F 27/255

(57) ABSTRACT

There is provided a power inductor including: a lower substrate formed of a magnetic material; an inductor main body formed on an upper surface of the lower substrate; at least one coil portion including a conductive via and formed inside the inductor main body; and external electrodes formed at both ends of the inductor main body and electrically connected to the at least one coil portion.

### CROSS-REFERENCE TO RELATED APPLICATIONS

This application is a Divisional Application of U.S. application Ser. No. 13/729,735 filed on Dec. 28, 2012 which in turn claims the priority of Korean Patent Application No. 10-2011-0145750 filed on Dec. 29, 2011, in the Korean Intellectual Property Office, the disclosure of which is incorporated herein by reference.

### BACKGROUND OF THE INVENTION

1. Field of the Invention

The present invention relates to a power inductor and a method of manufacturing the same.

2. Description of the Related Art

In general, electronic components using ceramic materials include capacitors, inductors, piezoelectric devices, varistors, thermisters, and the like.

Among these ceramic electronic components, inductors are important passive devices constituting electronic circuits, together with resistors and capacitors, and are used as components for removing noise or constituting LC resonance circuits.

Such inductors may be classified into various types, such as multilayer-type inductors, winding-type inductors, and thin film-type inductors according to structures thereof, which are different in terms of manufacturing methods as well as in ranges of application thereof.

Winding-type inductors are formed by winding coils around, for example, a ferrite core. Since stray capacitance between coils, i.e. capacitance between conductors may be generated, if the number of coil windings is increased in order to obtain high-capacity inductance, high frequency characteristics may problematically deteriorate.

Multilayer-type inductors are manufactured as multilayered structures in which ceramic sheets formed of a plurality of ferrites or dielectric materials having low dielectric constants are laminated. Metal patterns having coil form are formed on respective ceramic sheets and are sequentially connected by conductive vias formed in respective ceramic sheets, and overlap one another in a lamination direction.

Such multilayer-type inductors are advantageous for mass production and have excellent high frequency characteristics while inductance is limited therein due to a limited number of laminated electrodes, and allowable current cannot be sufficiently obtained due to limited internal electrode width.

Meanwhile, as the development of IT technology accelerates the development of small-sized thin-film devices, market demand for small-sized thin-film devices is increasing.

However, conventional inductors manufactured in surface mounted device (SMD) forms may have problematically thick chips, since a thickness loss may occur due to a thickness of a substrate.

To solve this problem, a thickness of a coil portion is reduced by an amount equal to a thickness loss of a substrate, which may problematically cause deterioration of inductor capacitance.

In the related art document, an insulation layer is formed of resin rather than a magnetic material.

### RELATED ART DOCUMENT

(Patent Document 1) Korean Patent Laid-Open Publication No. 2010-0037000

### SUMMARY OF THE INVENTION

An aspect of the present invention provides a power inductor appropriate for a small-sized chip by obtaining high saturation current and preventing thickness loss due to a substrate thickness.

According to an aspect of the present invention, there is provided a power inductor including: a lower substrate formed of a magnetic material; an inductor main body formed on an upper surface of the lower substrate; at least one coil portion including a conductive via and formed inside the inductor main body; and external electrodes formed at both ends of the inductor main body and electrically connected to the at least one coil portion.

The upper surface of the lower substrate may be closely connected to a lower portion of the at least one coil portion.

The lower substrate may be formed of one selected from the group consisting of a silicon steel sheet, permalloy including 80 weight % of Ni and 20 weight % of Fe, sendust including 85 weight % of Fe, 9 weight % of Si and 6 weight % of Al, ferrite, and prepreg.

The lower substrate and the at least one coil portion may have a lower cover layer interposed therebetween, and the lower cover layer may be formed of a mixture of ferritic or magnetic metal powder and a polymer.

The at least one coil portion may have an insulation layer formed at a perimeter thereof.

The at least one coil portion may have an upper substrate disposed on an upper portion thereof, the upper substrate being formed of a magnetic material.

The upper surface of the lower substrate may be closely connected to a lower portion of the at least one coil portion, and the at least one coil portion may have an upper substrate disposed on an upper portion thereof, the upper substrate being formed of a magnetic material.

The lower substrate and the upper substrate may be formed of one selected from the group consisting of a silicon steel sheet, permalloy including 80 weight % of Ni and 20 weight % of Fe, sendust including 85 weight % of Fe, 9 weight % of Si and 6 weight % of Al, ferrite, and prepreg.

The at least one coil portion may have an upper cover layer disposed on an upper portion thereof, and the upper cover layer may be formed of a mixture of ferritic or magnetic metal powder and a polymer.

The lower substrate and the at least one coil portion may have a lower cover layer interposed therebetween, the at least one coil portion may have an upper cover layer formed on an upper portion thereof, and the upper cover layer and the lower cover layer may be formed of a mixture of ferritic or magnetic metal powder and a polymer.

The inductor main body may be formed of a mixture of ferritic or magnetic metal powder and a polymer.

The magnetic metal powder may include at least one selected from the group consisting of Fe—Ni, amorphous Fe, Fe, and Fe—Cr—Si.

The polymer may include at least one selected from the group consisting of epoxy, polyimide, and liquid crystal polymer (LCP).

According to another aspect of the present invention, there is provided a method of manufacturing a power inductor, the method including: disposing at least one coil portion including a conductive via on a lower substrate formed of a magnetic material; forming an inductor main body by disposing a material including a mixture of ferritic or magnetic metal powder and a polymer on the lower substrate having the at least one coil portion disposed thereon; and forming external electrodes at both ends of the inductor main body so that the external electrodes are electrically connected to the at least one coil portion.

The disposing of the at least one coil portion may include laminating a plurality of coil portions on an upper surface of the lower substrate so that the coil portions are electrically connected through the conductive via.

The method may further include forming a lower cover layer by laminating a cover sheet formed of a mixture of ferritic or magnetic metal powder and a polymer on the lower substrate, before the disposing of the at least one coil portion.

The method may further include forming a lower cover layer by printing paste including a mixture of ferritic or magnetic metal powder and a polymer on the lower substrate, before the disposing of the at least one coil portion.

The method may further include laminating an upper substrate formed of a magnetic material on an upper portion of the at least one coil portion, before the forming of the external electrodes.

The method may further include forming an upper cover layer by laminating a cover sheet formed of a mixture of magnetic metal powder and a polymer on an upper portion of the at least one coil portion, after the forming of the inductor main body.

The method may further include forming an upper cover layer by printing paste including a mixture of ferritic or magnetic metal powder and a polymer on an upper portion of the at least one coil portion, after the forming of the inductor main body.

The method may further include forming an insulation layer at a perimeter of the at least one coil portion, before the disposing of the at least one coil portion.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view of a structure of an inductor according to an embodiment of the present invention;

FIG. 2 is a cross-sectional view of the inductor taken along line A-A′ of FIG. 1;

FIG. 3 is a cross-sectional view of an inductor taken along line A-A′ according to another embodiment of the present invention; and

FIG. 4 is a cross-sectional view of an inductor taken along line A-A′ according to another embodiment of the present invention.

### DETAILED DESCRIPTION OF THE EMBODIMENTS

Embodiments of the present invention will now be described in detail with reference to the accompanying drawings.

This invention may, however, be embodied in many different forms and should not be construed as being limited to the embodiments set forth herein.

Rather, these embodiments are provided so that this disclosure will be thorough and complete, and will fully convey the scope of the invention to those skilled in the art.

Thus, the shapes and sizes of elements in the drawings may be exaggerated for clarity, and like reference numerals will be used throughout to designate the same or like elements.

In addition, unless explicitly described to the contrary, the word “comprise” and variations such as “comprises” or “comprising,” will be understood to imply the inclusion of stated elements but not the exclusion of any other elements.

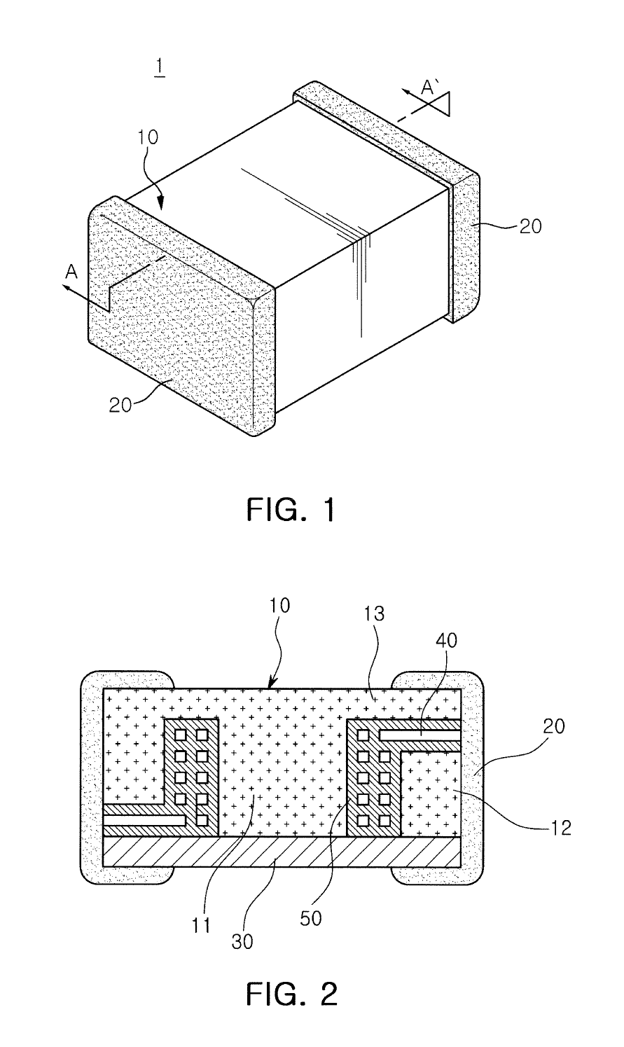

FIG. 1 is a schematic perspective view of a structure of an inductor according to an embodiment of the present invention. FIG. 2 is a cross-sectional view of the inductor taken along line A-A′ of FIG. 1.

Referring to FIGS. 1 and 2, an inductor 1 according to an embodiment of the present invention includes a lower substrate 30 formed of a magnetic material, an inductor main body 10 formed on an upper surface of the lower substrate 30, a coil portion 40 formed inside the inductor main body 10, and a pair of external electrodes 20 formed on both ends of the inductor main body 10 and electrically connected to the coil portion 40.

Hereinafter, for convenience of description, a part positioned inside the coil portion 40 of the inductor main body 10 is referred to as a core portion 11 and a part positioned outside the coil portion 40 is referred to as a core boundary portion 12.

The lower substrate 30 is formed of the magnetic material, and serves as a passage through which magnetic flux circulates in the inductor 1 when current is applied thereto, as well as a function of a substrate, and thus, high inductance and low direct current resistance may be achieved, and an overall thickness of the inductor 1 may be reduced.

The lower substrate 30 may be formed of one selected from the group consisting of a silicon steel sheet, permalloy including 80 weight % of Ni and 20 weight % of Fe, sendust including 85 weight % of Fe, 9 weight % of Si and 6 weight % of Al, ferrite, and prepreg.

The inductor main body 10 may be formed by printing paste including a mixture of ferritic or magnetic metal powder and a polymer on the lower substrate 30 on which the coil portion 40 is disposed.

Here, an upper surface of the lower substrate 30 may be closely connected to a lower portion of the coil portion 40.

Further, in the case in which the inductor main body 10 is formed of the mixture of magnetic metal powder and a polymer, the magnetic metal powder may include at least one selected from the group consisting of Fe—Ni, amorphous Fe, Fe, and Fe—Cr—Si, and the polymer may include at least one selected from the group consisting of epoxy, polyimide, and liquid crystal polymer (LCP).

The coil portion 40 includes a conductive via (not shown) formed by penetrating the coil portion 40 in a thickness direction thereof. The coil portion 40 may be configured by forming a metal wire in a spiral shape and laminating two or more coil portions formed of the spiral-shaped metal wire if necessary, or by winding the metal wire to a predetermined height in a bobbinless cylindrical shape. However, the present invention is not limited thereto.

Here, an overall height of the coil portion 40 may be minimized within a capacity range required by the inductor 1 so as to realize a small-sized chip.

Further, the conductive via may be formed through using a method of forming a through hole in a sheet and filling the through hole with conductive paste. However, the present invention is not limited thereto.

In this regard, the conductive paste may include a metal such as Ag, Ag—Pd, Ni, and Cu.

Both ends of the above-described coil portion 40 may be withdrawn to both ends of the inductor main body 10 and electrically connected to the pair of external electrodes 20, respectively.

Referring to FIG. 2, an upper cover layer 13 may be formed on an upper portion of the coil portion 40 in order to prevent deterioration in basic characteristics of the coil portion 40.

The upper cover layer 13 may be formed by laminating a plurality of sheets formed of a mixture of ferritic or magnetic metal powder and a polymer on the core portion 11, the core boundary portion 12, and the coil portion 40, or by printing paste formed of the same materials as those of the sheets on the core portion 11, the core boundary portion 12, and the coil portion 40.

Further, in the case in which the upper cover layer 13 is formed of a mixture of magnetic metal powder and a polymer, the magnetic metal powder may include at least one selected from the group consisting of Fe—Ni, amorphous Fe, Fe, and Fe—Cr—Si, and the polymer may include at least one selected from the group consisting of epoxy, polyimide, and LCP.

The external electrodes 20 are formed on an external surface of the inductor main body 10 and are electrically connected to both ends of the coil portion 40, respectively.

The external electrodes 20 may be formed through using a method of immersing the inductor main body 10 in a conductive paste, a printing method, a deposition method or a sputtering method.

Here, the conductive paste may include a metal such as Ag, Ag—Pd, Ni, and Cu. An Ni plating layer and an Sn plating layer may be formed on surfaces of the external electrodes 20 if necessary.

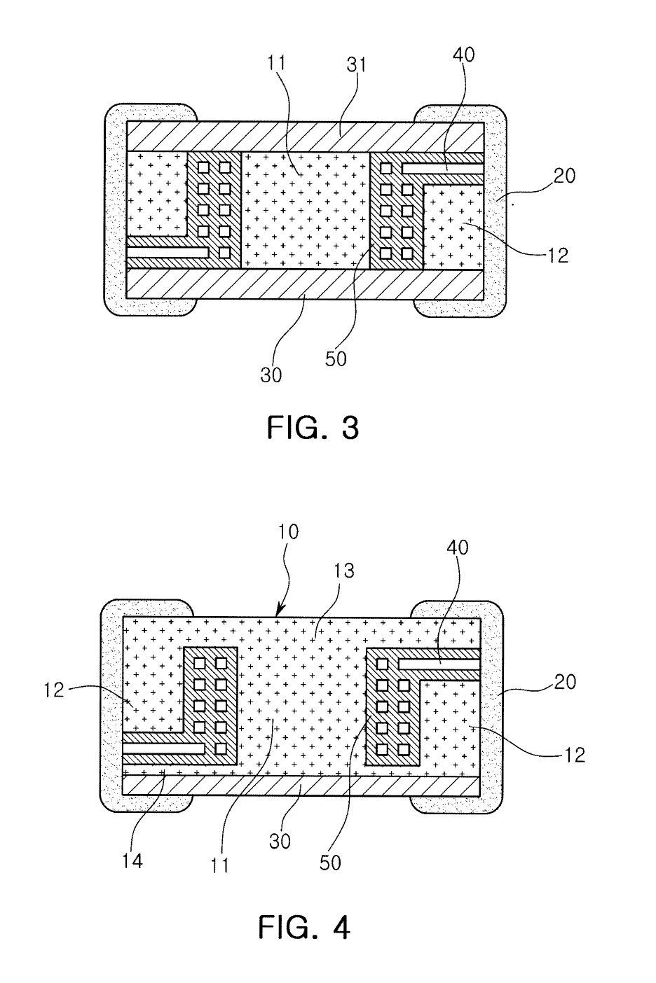

FIG. 3 is a cross-sectional view of an inductor taken along line A-A′ according to another embodiment of the present invention. The same reference numerals between the previous embodiment and the present embodiment denote the same elements, and uncommon elements therebetween will now be described.

Referring to FIG. 3, an upper substrate 31 formed of a magnetic material may be formed on the core portion 11, the core boundary portion 12, and the coil portion 40.

The upper substrate 31 is formed of a magnetic material that is similar to or is identical to the material of the lower substrate 30, and serves as a passage through which magnetic flux circulates in the inductor 1 when current is applied thereto, as well as a function of a substrate, and thus, high inductance and low direct current resistance may be achieved, and an overall thickness of the inductor 1 may be reduced.

Here, the magnetic substrates, that is, the upper substrate 31 and the lower substrate 30 disposed in the lower portion of the inductor main body 10 have a vertically symmetrical structure, thereby further enhancing a circulation effect of the magnetic flux.

The upper substrate 31 may be formed of one selected from the group consisting of a silicon steel sheet, permalloy including 80 weight % of Ni and 20 weight % of Fe, sendust including 85 weight % of Fe, 9 weight % of Si and 6 weight % of Al, ferrite, and prepreg.

FIG. 4 is a cross-sectional view of an inductor taken along line A-A′ according to another embodiment of the present invention. The same reference numerals between the previous embodiment and the present embodiment denote the same elements, and uncommon elements therebetween will now be described.

Referring to FIG. 4, a lower cover layer 14 may be formed between the lower substrate 30 and the coil portion 40 in order to prevent deterioration in basic characteristics of the coil portion 40.

The lower cover layer 14 may be formed by laminating a plurality of sheets formed of a mixture of ferritic or magnetic metal powder and a polymer on the lower substrate 30, or by printing paste including the same materials as those of the sheets on the lower substrate 30.

Further, in the case in which the lower cover layer 14 is formed of a mixture of magnetic metal powder and a polymer, the magnetic metal powder may include at least one selected from the group consisting of Fe—Ni, amorphous Fe, Fe, and Fe—Cr—Si.

The polymer may include at least one selected from the group consisting of epoxy, polyimide, and LCP.

Meanwhile, an insulation layer 50 may be formed on outer edges of the coil portion 40 to surround the coil portion 40 in order to insulate the coil portion 40 and the inductor main body 10.

Here, the insulation layer 50 may use, for example, polymer as a material having insulation characteristics.

Hereinafter, a method of manufacturing a power inductor according to an embodiment of the present invention will now be described.

The coil portion 40 is disposed on the lower substrate 30 formed of a magnetic material.

The coil portion 40 may include a conductive via (not shown) formed by forming a through hole in a thickness direction and filling the through hole with conductive paste. The conductive paste may include a metal such as Ag, Ag—Pd, Ni, and Cu.

Further, the through hole may be formed by a laser drilling or a punching process, without being limited thereto.

Further, the coil portion 40 may be laminated in multiple layers. The respective laminated coil portions 40 may contact one another through the conductive vias and may be electrically connected to each other.

Here, the insulation layer 50 may be formed on the outer edges of the coil portion 40 using an insulating material such as polymer having insulation characteristics to surround the coil portion 40.

Meanwhile, before the coil portion 40 is disposed on the lower substrate 30, the lower cover layer 14 may be formed by further laminating a cover sheet formed of a mixture of ferritic or magnetic metal powder and a polymer on the lower substrate 30, or by printing paste including the same materials as those of the cover sheet on the lower substrate 30.

Here, the magnetic metal powder may include at least one selected from the group consisting of Fe—Ni, amorphous Fe, Fe, and Fe—Cr—Si. The polymer may include at least one selected from the group consisting of epoxy, polyimide, and LCP.

Next, the inductor main body 10 is formed by disposing the material including a mixture of ferritic or magnetic metal powder and a polymer on the lower substrate 30.

Here, in the case in which the inductor main body 10 is formed of a mixture of magnetic metal powder and a polymer, the magnetic metal powder may include at least one selected from the group consisting of Fe—Ni, amorphous Fe, Fe, and Fe—Cr—Si, and the polymer may include at least one selected from the group consisting of epoxy, polyimide, and LCP.

Next, the upper cover layer 13 may be formed by further laminating a cover sheet formed of a mixture of ferritic or magnetic metal powder and a polymer on the coil portion 40 and the inductor main body 10, or by printing paste including the same materials as those of the cover sheet on the coil portion 40 and the inductor main body 10.

Here, the magnetic metal powder may include at least one selected from the group consisting of Fe—Ni, amorphous Fe, Fe, and Fe—Cr—Si. The polymer may include at least one selected from the group consisting of epoxy, polyimide, and LCP.

Next, the inductor main body 10 is fired, and the pair of external electrodes 20 are formed at both ends of the inductor main body 10 so that the external electrodes 20 may be electrically connected to both ends of the coil portion 40, respectively.

The external electrodes 20 may be formed through using a method of immersing the inductor main body 10 in a conductive paste, a printing method, a deposition method or a sputtering method.

In this regard, the conductive paste may include a metal such as Ag, Ag—Pd, Ni, and Cu. An Ni plating layer and an Sn plating layer may be formed on the surfaces of the external electrodes 20 if necessary.

Meanwhile, before the external electrodes 20 are formed, as shown in FIG. 3, the upper substrate 31 formed of a magnetic material may be laminated on an upper portion of the coil portion 40 or an upper portion of the upper cover layer 13.

The upper substrate 31 is formed of a magnetic material that is similar to or is identical to that of the lower substrate 30, and serves as a passage through which magnetic flux circulates in the inductor 1 when current is applied thereto, as well as a function of a substrate, and thus, high inductance and low direct current resistance may be achieved, and an overall thickness of the inductor 1 may be reduced.

The upper substrate 31 may be formed of one selected from the group consisting of a silicon steel sheet, permalloy including 80 weight % of Ni and 20 weight % of Fe, sendust including 85 weight % of Fe, 9 weight % of Si and 6 weight % of Al, ferrite, and prepreg.

As set forth above, according to embodiments of the invention, a substrate is formed of a magnetic material, thereby preventing a thickness loss due to a thickness of a conventional substrate, which reduces a restriction of the size of the substrate, thereby facilitating scale-up, and reduces a thickness of a chip, thereby achieving a small-sized chip.

Further, a ferritic material allows for improvements in terms of a short between electrodes and material loss due to a high frequency and allows for high saturation current during heating.

While the present invention has been shown and described in connection with the embodiments, it will be apparent to those skilled in the art that modifications and variations can be made without departing from the spirit and scope of the invention as defined by the appended claims.

What is claimed is:

1. A power inductor comprising:
a lower substrate formed of a magnetic material;
an inductor main body formed on an upper surface of the lower substrate;
at least one coil portion including a conductive via and formed inside the inductor main body; and
external electrodes formed at both ends of the inductor main body and electrically connected to the at least one coil portion.

2. The power inductor of claim 1, wherein the upper surface of the lower substrate is closely connected to a lower portion of the at least one coil portion.

3. The power inductor of claim 1, wherein the lower substrate is formed of one selected from the group consisting of a silicon steel sheet, permalloy including 80 weight % of Ni and 20 weight % of Fe, sendust including 85 weight % of Fe, 9 weight % of Si and 6 weight % of Al, ferrite, and prepreg.

4. The power inductor of claim 1, wherein the lower substrate and the at least one coil portion have a lower cover layer interposed therebetween, and
the lower cover layer is formed of a mixture of ferritic or magnetic metal powder and a polymer.

5. The power inductor of claim 4, wherein the magnetic metal powder includes at least one selected from the group consisting of Fe—Ni, amorphous Fe, Fe, and Fe—Cr—Si.

6. The power inductor of claim 4, wherein the polymer includes at least one selected from the group consisting of epoxy, polyimide, and liquid crystal polymer (LCP).

7. The power inductor of claim 1, wherein the at least one coil portion has an insulation layer formed at a perimeter thereof.

8. The power inductor of claim 1, wherein the at least one coil portion has an upper cover layer disposed on an upper portion thereof, and
the upper cover layer is formed of a mixture of ferritic or magnetic metal powder and a polymer.

9. The power inductor of claim 1, wherein the lower substrate and the at least one coil portion have a lower cover layer interposed therebetween,
the at least one coil portion has an upper cover layer formed on an upper portion thereof, and
the upper cover layer and the lower cover layer are formed of a mixture of ferritic or magnetic metal powder and a polymer.

10. The power inductor of claim 8, wherein the magnetic metal powder includes at least one selected from the group consisting of Fe—Ni, amorphous Fe, Fe, and Fe—Cr—Si.

11. The power inductor of claim 8, wherein the polymer includes at least one selected from the group consisting of epoxy, polyimide, and liquid crystal polymer (LCP).

12. The power inductor of claim 8, wherein the at least one coil portion has an insulation layer formed at a perimeter thereof.

13. The power inductor of claim 1, wherein the inductor main body is formed of a mixture of ferritic or magnetic metal powder and a polymer.

14. The power inductor of claim 13, wherein the magnetic metal powder includes at least one selected from the group consisting of Fe—Ni, amorphous Fe, Fe, and Fe—Cr—Si.

15. The power inductor of claim 13, wherein the polymer includes at least one selected from the group consisting of epoxy, polyimide, and liquid crystal polymer (LCP).
